(19) United States
(12) Patent Application Publication
(10) Pub. No.: US 2025/0025781 A1
(43) Pub. Date: Jan. 23, 2025

(54) WORD PUZZLE GAME AND TOURNAMENT

(71) Applicants: Fausto Bernardini, Brooklyn, NY (US); Paola Bellu, New York, NY (US)

(72) Inventors: Fausto Bernardini, Brooklyn, NY (US); Paola Bellu, New York, NY (US)

(73) Assignee: NewYorkShowsOff, New York, NY (US)

(21) Appl. No.: 18/780,221

(22) Filed: Jul. 22, 2024

Related U.S. Application Data
(60) Provisional application No. 63/515,106, filed on Jul. 23, 2023.

(51) Int. Cl. A63F 13/46; A63F 3/04; A63F 13/798

(52) U.S. Cl. CPC A63F 13/46; A63F 13/798; A63F 2003/0428

(57) ABSTRACT

The present invention describes a word puzzle game and method of playing a single game or tournament. The invention comprises a board on which to form interlocking words, a tray in which letters are provided and refilled in successive rounds, and a scoring system that attributes points to words on the board based on letter values and bonus points for longer words and for using all the given letters. Objective of the game is to use all the letters in each round, thus completing the puzzle. Differently from prior art, each player in a tournament gets the same letter sequence, each player plays on their own board, and letters can be rearranged on the board. Players can play the game multiple times during the tournament to improve their score. At the end of the tournament, the player(s) with the highest score are declared the winners.

### BACKGROUND OF THE INVENTION

Word puzzles are a popular form of entertainment, relaxation, and improvement of mental fitness. They have existed for many years in magazines and newspapers (e.g. crossword puzzles were invented in 1913), as board games (such as Scrabble) and more recently as video games, especially popular on mobile devices (such as smartphones and tablets). Numerous word games are known as shown in patents issued, such as: U.S. Pat. No. 6,623,009 to Kraemer et al. on 23 Sep. 2003; U.S. Pat. No. 6,279,911 to Cherry on 28 Aug. 2001; U.S. Pat. No. 5,788,238 to LeBriton et al on 4 Aug. 1998; U.S. Pat. No. 5,586,765 to Lackey on 24 Dec. 1996.

### BRIEF SUMMARY OF THE INVENTION

The present game follows the pattern of crossword puzzles, where words are laid out on a rectangular grid (board) made of square tiles, with word letters occupying adjacent tiles in a horizontal (across) or vertical (down) sequence. Words are separated by a special tile (usually black), used wherever a letter is not present. All words on the board need to be valid according to a provided allowable word list; words need to interlock (e.g., share exactly one letter with another word), and they need to be unique (no two, or more, equal words on the board).

Differently from a crossword puzzle, where the pattern of board tiles to be filled with letters is fixed and a list of definitions (prompts) are given to the player to guess the words, the present invention asks the player to create the board using a letter sequence, provided in a separate tray. The game proceeds in multiple rounds. Initially, the board is completely filled with black tiles, and a number of letters to be played is provided in the tray. The player arranges the letters on the board according to the rules above, trying to use all of them in order to solve the daily puzzle. Each letter is assigned a point value, and those points are added up for each word that uses the letter. In addition, bonus points are granted for longer words, as well as for using all the letters from the tray. When the player is happy with the board, the player will move on to the next round, where the tray will be refilled with new letters. In the following round, the player may decide to rearrange all the letters on the board and in the tray, including those that formed words in the previous round. Letters may be returned to the tray as well. At the end of a prespecified number of rounds, the players that used all the letters in each round will have solved the puzzle. The total score from all rounds, plus applicable bonus points, is the player's game score. The game scores are published in a tournament leaderboard at the end of each game to establish the winner(s) of the daily tournament, and a record page is updated to show the all-time highest scores.

Differently from other word games, the present invention: (1) Provides all players in the tournament with exactly the same letter sequence, eliminating any element of luck in the game and enabling a single tournament with many players; (2) Gives the player the ability to rearrange letters, or recall them to the tray at any time during a round, a unique feature never used before; (3) Does not require the player to share their board with anybody, allowing the game and tournaments to proceed in parallel for many players around the world; (4) Introduces a “parking” tray to help rearrange words on the board.

### BRIEF DESCRIPTION OF THE DRAWINGS

FIG. 1 illustrates an example screenshot in an electronic embodiment of the game where the screenshot shows an initial look for the word game where the board is filled with black squares, and the tray is filled with the initial letters from the predefined (and equal for all players) game letter sequence. The screenshot also shows an optional “parking tray” where letters can be placed temporarily during a round to help form words.

FIG. 2 illustrates an example screenshot in an electronic embodiment of the game where the screenshot shows the board and tray after all first-round letters have been placed on the board to form valid interlocking words.

FIG. 3 illustrates an example screenshot in an electronic embodiment of the game where the screenshot shows the board and tray after a second round has been played, and all letters from the tray have been used.

FIG. 4 illustrates an example screenshot in an electronic embodiment of the game where the screenshot shows the board and tray right after advancing to the third (and, in this example, last) round. The tray has been refilled with letters from the predefined game letter sequence.

FIG. 5 illustrates an example screenshot in an electronic embodiment of the game where the screenshot shows the board and tray after playing all the letters in the final round of the game. The final score is indicated in the top right corner of the screenshot.

FIG. 6 illustrates an example screenshot in an electronic embodiment of the game where the screenshot shows a pop-up dialog box informing the user that their score has been posted to the current tournament leaderboard.

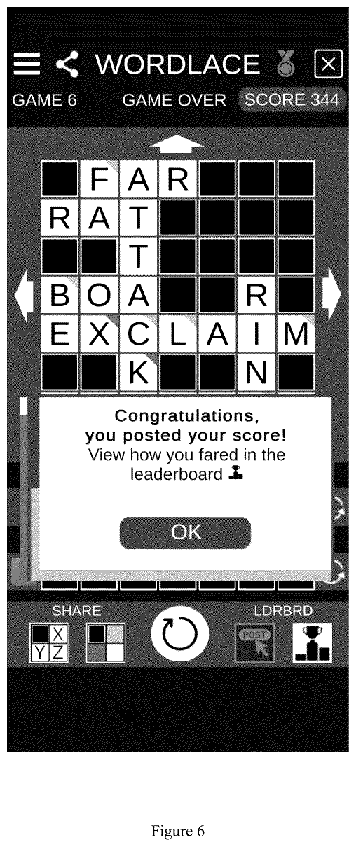

FIG. 7 illustrates an example screenshot in an electronic embodiment of the game where the screenshot shows the leaderboard for a past tournament.

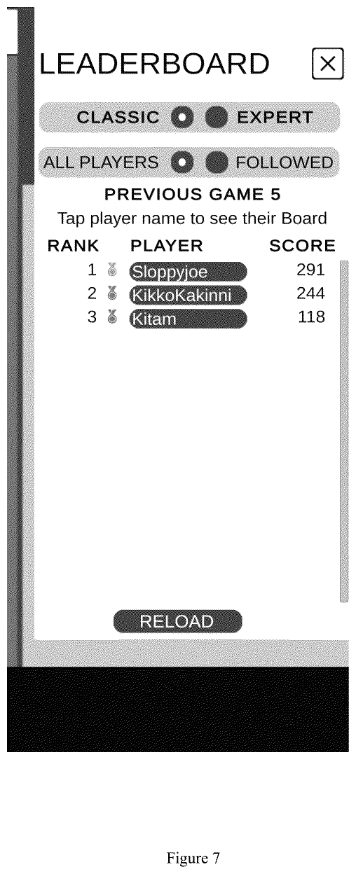

FIG. 8 illustrates an example screenshot in an electronic embodiment of the game where the screenshot shows a menu of options available to the player.

FIG. 9 illustrates an example grid 4 for laying out the game letter sequence in a printed or physical embodiment of the game, and the board 5 on which to form interlocking words. The first row 1 of the grid shows the first set of letter-tiles, with two letters 2 and 3 marked with colored triangles to signify a higher point-value.

FIG. 10 illustrates a possible embodiment of letter-tiles in a physical embodiment of the game. A stack 2 of four letter-tiles 1, all representing the same letter, is grouped together by interlocking the tiles. There are as many tiles in a group as there are players in the game (four in this example). Each tile 3 is shaped in such a way that it interlocks with other tiles, as can be seen in 4, showing the underside of a tile.

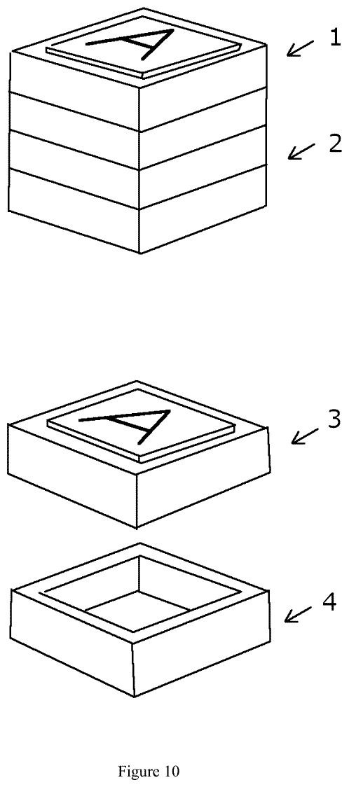

### DETAILED DESCRIPTION

Before the methods and word games are explained in detail, it is to be understood that the example methods and word games described herein are not limited in their application to the details of construction and the arrangements of the components set forth in the following description or illustrated in the drawings. The methods and word games described herein are capable of other forms and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items.

The objective of the word puzzle game is to form interlocking words on a board using all the letters given in each round. For competitive players, the objective is to score as many points as possible. Here we describe the rules of the game:
1. The game consists of an n×m board, and a tray with p letters. Note that n, m and p may be the same number but not necessarily. The included drawings represent one particular embodiment of the invention where m=n=p=7. Each letter is assigned a point value. For example, letters that are more frequent in the playing language may be assigned a lower value, while letters that are uncommon will be assigned a higher value.
2. The sequence of letters that will appear on the tray is pre-generated (e.g., randomly extracted from a letter-tile bag, or computed electronically) and assigned to all players. The players decide ahead of time how many rounds r they want to play. The letter sequence will comprise r×p letters.
3. Letters must be arranged on the board so as to form a valid crossword puzzle, that is:
   a. All words exist in the chosen language (according to a provided allowable word list);
   b. All words intersect at least another word, i.e. every two words share exactly one letter;
   c. There are no duplicate words; and
   d. At least one additional letter is used in each round.
4. In the first round, the board will be filled with black squares, indicating the absence of letters. The tray will be filled with the first p letters from the pre-generated letter sequence. The player can move the letters from the tray to the board to form interlocking words.
5. When the board is valid according to the rules above, the current score will be displayed to the player. The score is computed according to the following rules:
   a. For each word, add the point score of each of its letters;
   b. Assign bonus points for specific words. For example, n-letter words may add a bonus equal to double the point score of the word, while (n−1)-letter words may add a bonus equal to the point score of the word. These are just examples, as other bonus-point formulas can be easily adopted.
6. Once the player is satisfied with their first board, having used some or all of the letters on their tray and having formed valid words, the player will be able to advance to the next round.
7. In the next round, the tray will be refilled with letters from the preassigned sequence. The player will move letters around to form new words and maximize their score. They can move every letter already on the board, move letters from the tray to the board, and vice versa. At least one letter from the current tray must be used in each round.
8. The game continues for a pre-established number r of rounds. In the last round, the player may be given additional bonuses, for example for using all of their letters across all rounds.
9. The final score will be the sum of all scores from each round, including bonuses.
10. The players that used all the letters given in each round will have solved the puzzle.
11. Scores may be posted to a tournament leaderboard. Tournaments will have a start and end time (for example a daily tournament starting at midnight each day), and may be played by all players, or only among a subgroup (for example, a player's friends, or a group of players with similar skill levels.)
12. Players can decide to play the game multiple times during the tournament, trying to attain a higher score than before.
13. At the end of the tournament, the player (or players) with the highest score will be declared the tournament winner(s).

The game can be offered at different levels of difficulty, for example:
1. By playing fewer or more rounds (the later rounds become more difficult as the board fills up with letters).
2. By changing the size of the board and the number of letters in the tray.
3. By fixing some of the letters on the board.
4. By fixing some of the black squares.
5. By allowing for a larger allowable word list, or one that is specialized to a specific domain (e.g. Biology.)

It is evident for a skilled person how the invention can be manifested as a printed game, a board game, or an online game.

In its printed form, to be published for example in a magazine or newspaper, the predefined letter sequence may be printed next to the board (embodied as a printed grid). The players will play their first tray of letters (i.e., the first p letters of the sequence), using pencil and eraser to try different combinations of words on their board. At the end of each round, the players will mark with a sign the letters of the sequence that have been used, and consider the next letters up the (round number×p)-th letter of the sequence, and so on, following the rules above.

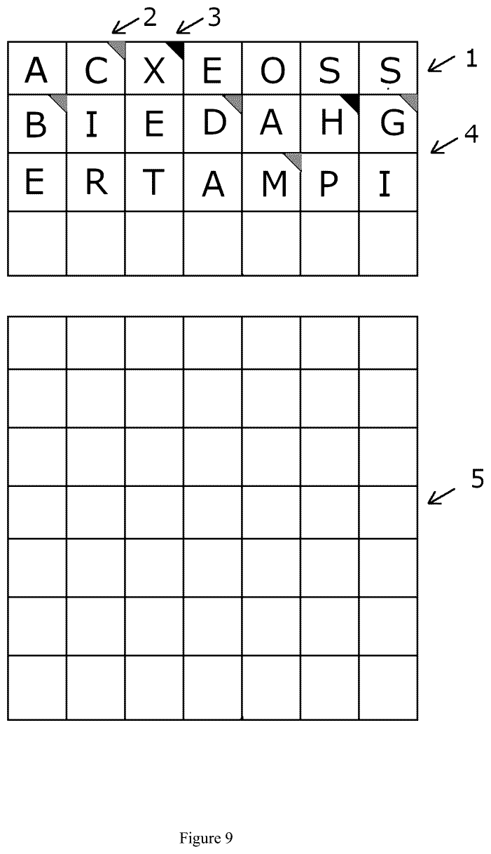

In an embodiment as a physical board game, each player will be provided with an n×m physical grid and p-letter tray, on which to place physical tiles with a letter printed on them. Players will in turn extract a group of letter-tiles from a bag to form a sequence of p×r letters (p letters for each of the r rounds in the game.) Each group contains the same letter, repeated on as many tiles as there are players. Grouping can be accomplished by making the tiles in a way such that they interlock with each other, as shown in FIG. 9. Once the sequence is ready, players will start the game by taking one tile each from the first p tile-groups. Each of the players will then form words on their boards, refill their tray from the sequence of tile-groups to play the next round, and continue as explained above.

The game is also well suited to be played on internet-connected mobile devices. As illustrated in the accompanying drawings, showing a possible embodiment of the invention, the board and tray are represented as graphical grids on the device screen, and interaction occurs by tapping and dragging letters across the tray and board with one's fingers. Specific elements of the graphical user interface allow the player to advance to the next round and complete the game. Immediate feedback can be provided to the player while they play, for example whether a word is correct, if a word is a duplicate, their current score, bonuses, etc. In addition, the player can check the current game's leaderboard, as well as results from the previous tournament (for example, player names or avatars, scores and boards).

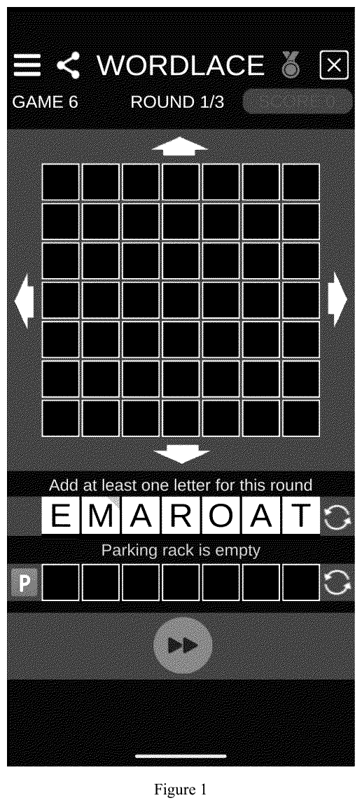

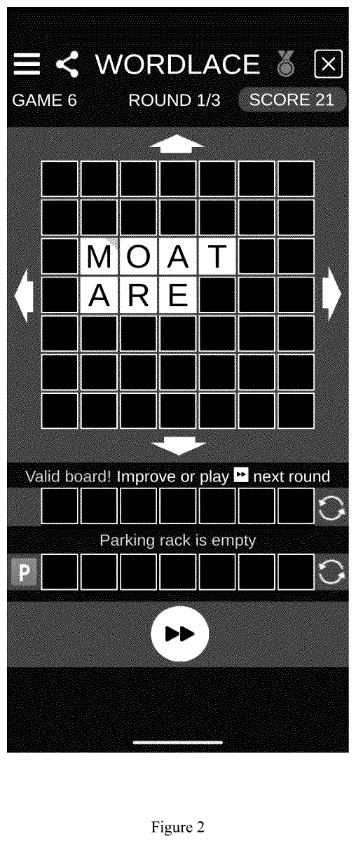

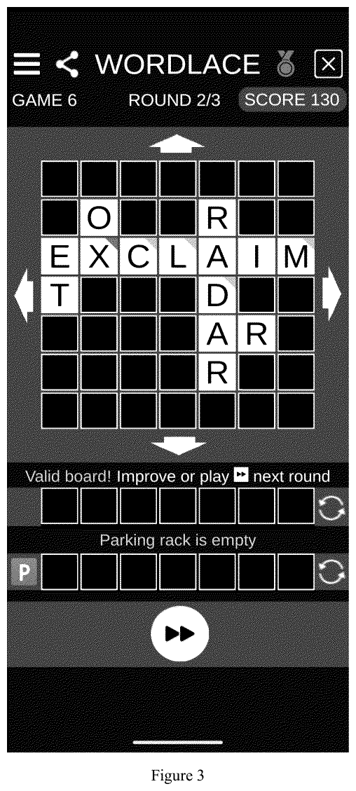

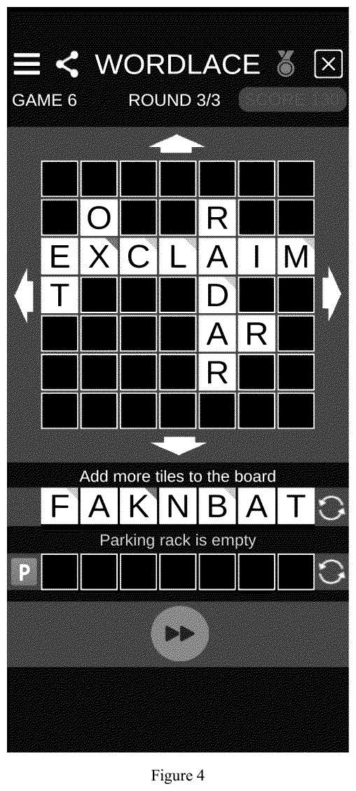

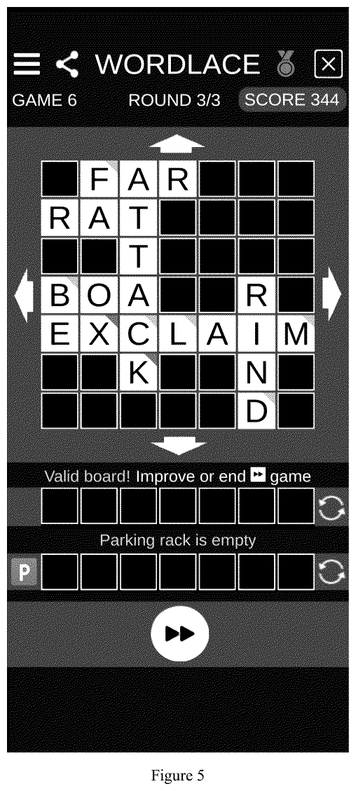

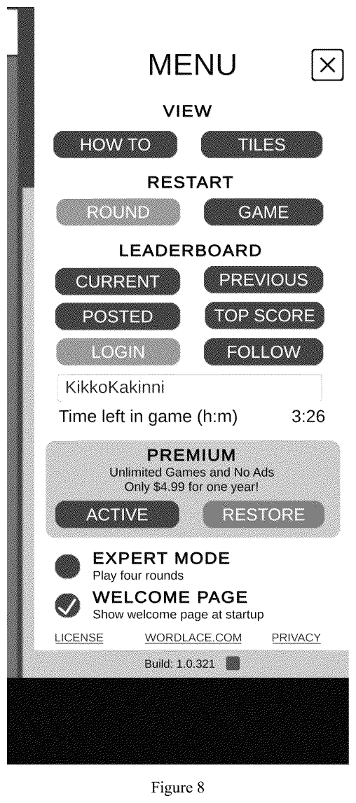

In a preferred embodiment of the invention, as illustrated in the FIGS. 1-5, an additional parking tray is provided to afford players extra temporary space to remove letters from the board while they rearrange and create new words, especially useful in later game rounds when more of the board tiles are occupied. A menu page, shown in FIG. 8, allows players to reset the game to the beginning of the game or beginning of the last round, see their current posted board and score, view current and previous leaderboard, and choose how many rounds they want to play (for example 3 or 4 rounds in a possible embodiment of the invention).

While the present invention has been described in considerable detail. it will be obvious to those skilled in the art that alterations may be made in the game itself or in the method for playing the game without departing from the concept and scope of the present invention as described in the following claims.

What we claim is:

1. A method of playing a word-puzzle game for one or more players, comprising:
a. A n×m grid (the board) initially filled with blank (or black) tiles;
b. A tray which will contain p tiles, each representing a letter of the alphabet;
c. A bag filled with tiles, at least one for each letter of the alphabet, but preferably with a number of tiles for each letter corresponding to the frequency of each letter in the chosen language of play (for example, a higher number of A-tiles compared to the number of Z-tiles if playing in English), each letter also being assigned a point value, preferably inversely proportional to their frequency in the language of choice (for example, a higher number of points for the letter Z than the letter A);
d. A sequence of p×r letters, where r is the number of rounds to be played, determined in advance of game play by randomly extracting letters from the tile bag, such sequence to be used by all players of the current game;
e. A set of rules to determine a valid board, i.e. that words need to be included in an agreed upon allowable word list, that words need to interlock (share exactly one letter with another word on the board), and that words need to be unique (no more than one occurrence on the board);
f. A scoring system which assigns points to each word, e.g. as the sum of the letter-points forming the word (letters at the intersection of two words will thus be counted twice);
g. Rules to assign bonus points to words, for example doubling or triple-ing the score of the word for longer words, as well as a special bonus for using all the letters in each round;
h. Optionally, a parking tray which players can use to temporarily store some letter-tiles while rearranging words on the board;
i. Rules to play a pre-set number r of rounds of the game, each round comprising the steps of:
i. Refilling the tray from the letter sequence with a number of letter-tiles equal to the number of letters used in the previous round (or p tiles in the first round);
ii. Moving tiles from the tray to the board, and across the board, to form interlocking words;
iii. Completing the round when the board is valid according to the rules above, and advancing the game to the next round;
iv. Assigning points to the player in each round, according to the scoring system and bonus points described above;
v. Declaring the game puzzle solved if the player has completed r rounds and used all the p letters in the tray in each round;
vi. Assigning a final score to the game by adding the scores in each round, plus any bonus points, according to the rules above;
j. Rules for a plurality of players to compete for the highest score in a tournament, in which:
i. The tournament begins and ends at predefined times (for example, at the same time each day);
ii. All players are given exactly the same sequence of letters to be played across all rounds (if the tray is of size p and the number of rounds to be played is r, the letter-sequence will have p×r letters);
iii. The game of each player is scored according to the scoring system and bonus points described above, and their score is published in a tournament leaderboard, accessible to all players;
iv. Players can re-play the game during the tournament duration to improve their score; and
v. At the end of the tournament, one or more winners are declared as the players who have scored the highest number of points.

2. A game-playing system and method that embodies the method described in claim 1, comprising:
a. An internet-connected computer device (such as a PC, laptop, smart phone, or tablet);
b. A board and tray rendered on the device screen;
c. A means of generating a random p×r-long letter sequence, and distributing such sequence to all players;
d. A means of filling the tray with the first p letters from the letter sequence;
e. A means of letting the player drag letters between the tray and board, and vice versa, as well as move the letters around the board in order to form words;
f. A means of determining a valid board;
g. A means of automatically scoring a valid board;
h. A means of advancing the game to the next round, up to the last round;
i. A means of publishing the final score in an online leaderboard, and rank players according to their score in the current tournament; and
j. A means of letting the players access current and past leaderboards to see the tournament's winners and their own ranking.

3. A game playing method, as described in claim 1, which is embodied as a printed game, to be played on paper with e.g. a pencil and eraser, such method comprising:
a. A means of showing the player the predefined letter sequence; and
b. A printed grid on which the player will form words using the given letters, following the steps and rules above.

4. A game playing method, as described in claim 1, which is embodied as a physical board game, such method comprising:
a. A grid printed on a flat board;
b. A tray in which to place the current round's letter-tiles;
c. A bag containing a plurality of letter-tile groups, each group being formed by a number of tiles equal to the number of players, such tiles interlocking with each other, forming tile groups, each group containing as many of the same letter-tile as there are players; and
d. A designated space to compose the letter sequence by lining up the p×r letter-tile groups extracted from the tile bag;
e. A rule be which each player will refill their tray by taking one tile from each of the tile groups in the sequence, in order, such as to replace the letter tiles used in the previous round (or p tiles in the first round); and
f. Following the same rules as above to form words, progress through r rounds, complete and score the game.
